(19) United States
(12) Patent Application Publication
(10) Pub. No.: US 2007/0203963 A1
(43) Pub. Date: Aug. 30, 2007

(54) PORTABLE COMPUTER

(75) Inventors: HSUAN-CHEN CHEN, Tu-Cheng (TW); JIE ZHANG, Shenzhen (CN); CHIEN-LI TSAI, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/556,181

(22) Filed: Nov. 3, 2006

(30) Foreign Application Priority Data
Feb. 11, 2006 (CN) 200620054978.7

(51) Int. Cl. G06F 1/16

(52) U.S. Cl. 708/100

(57) ABSTRACT

A portable computer includes a base unit, a cover unit, a main keyboard, and an input device. The cover unit is pivotably connected to the base unit. The main keyboard is mounted to the base unit. The main keyboard includes a plurality of keys. The input device is replaceably mounted to the base unit, for inputting one type of single special singal.

### BACKGROUND OF THE INVENTION

1. Field of the Invention

The present invention relates to portable computers incorporating an input device such as a numeric keypad or a graphics tablet.

2. Description of Related Art

A typical portable computer, such as a notebook computer, includes a base unit, and a cover unit pivotably connected to an end of the base unit. The base unit includes a top panel. The cover unit includes a screen. Generally, a standard keyboard is mounted to the top panel of the base unit of the notebook computer. The standard keyboard includes a plurality of keys each having special functions and positions. Because numeric keys of the standard keyboard of the notebook computer are not grouped together on the keyboard, it is inconvenient for special users, such as accountants or bank employees, who use numeric keys of the keyboard frequently.

To address aforementioned problem, an externally-connecting numeric keypad is provided to use with the notebook computer. However, the numeric keypad needs an additional cable to connect with the notebook computer. Also, when the notebook computer is being moved from one location to another, the numeric keypad detached from the notebook computer along with the cable additional is a cumbersome burden.

What is desired, therefore, is a portable computer having a keyboard which can meet the demands of special users.

### SUMMARY OF THE INVENTION

An exemplary portable computer includes a base unit, a cover unit, a main keyboard, and an input device. The cover unit is pivotably connected to the base unit. The main keyboard is mounted to the base unit. The main keyboard includes a plurality of keys. The input device is replaceably mounted to the base unit, for inputting one type of single special singal.

Other advantages and novel features will become more apparent from the following detailed description when taken in conjunction with the accompanying drawings, in which:

### BRIEF DESCRIPTION OF THE DRAWINGS

FIG. 1 is an exploded, isometric view of a portable computer in accordance with a first preferred embodiment of the present invention;

FIG. 2 is an assembled view of FIG. 1;

FIG. 3 is a partially-sectioned view of FIG. 2, but viewed from another aspect; and

FIG. 4 is an assembled, isometric view of a portable computer in accordance with a second preferred embodiment of the present invention.

### DETAILED DESCRIPTION OF THE INVENTION

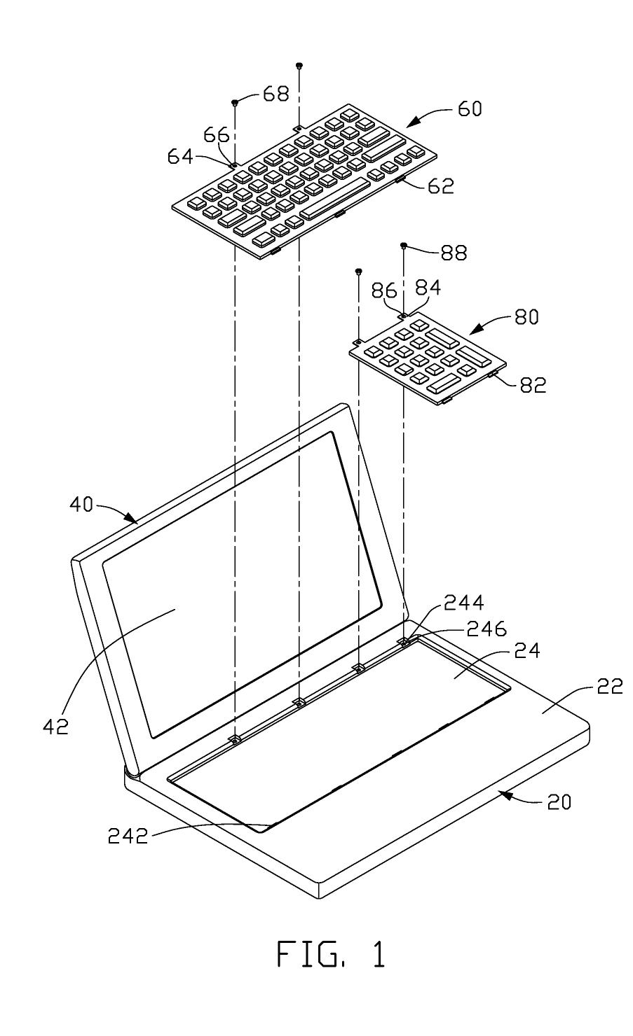

Referring to FIG. 1, a portable computer in accordance with a first preferred embodiment of the present invention is shown. The portable computer is a notebook computer in this embodiment. The notebook computer includes a base unit 20, a cover unit 40, a main keyboard 60, and an input device, such as a numeric keypad 80.

The base unit 20 includes a top panel 22. A rectangular depressed region 24 is formed in the top plate 22, adjacent the cover unit 40. The depressed region 24 forms a plurality of receiving slots 242 on a side thereof, and defines a plurality of cutouts 244 in an opposite side thereof. A threaded hole 244 is defined in a bottom bounding each cutout 244.

The cover unit 40 is pivotably connected to an end of the base unit 20. The cover unit 40 includes a screen 42. When the notebook computer is closed, the screen 42 is adjacent the top panel 22 of the base unit 20.

The main keyboard 60 is a rectangular plate including a plurality of keys. A plurality of projections 62 extends from a side of the main keyboard 60, corresponding to the receiving slots 242 of the base unit 20. A plurality of mounting tabs 64 is formed on an opposite side of the main keyboard 60, corresponding to the cutouts 244 of the base unit 20. Each mounting tab 64 defines a through hole 66.

The numeric keypad 80 is a rectangular plate including a plurality of numeric keys. A plurality of protrusions 82 extends from a side of the numeric keypad 80, corresponding to the receiving slots 242 of the base unit 20. A plurality of fixing tabs 84 is formed on an opposite side of the numeric keypad 80, corresponding to the cutouts 244 of the base unit 20. Each fixing tab 84 defines a through-hole 86.

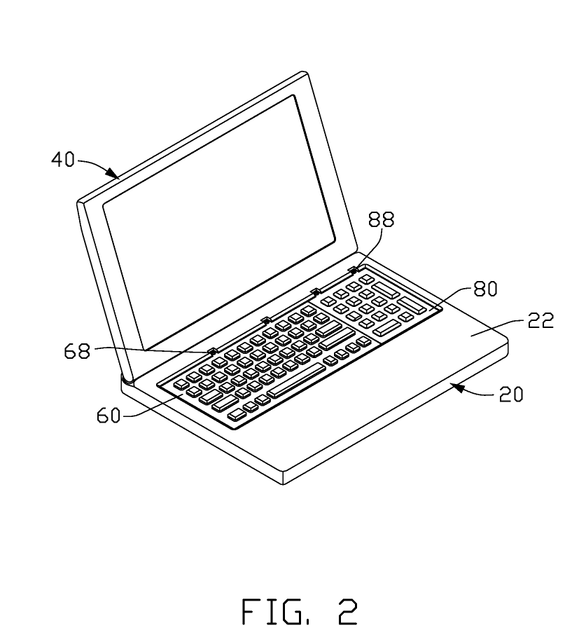

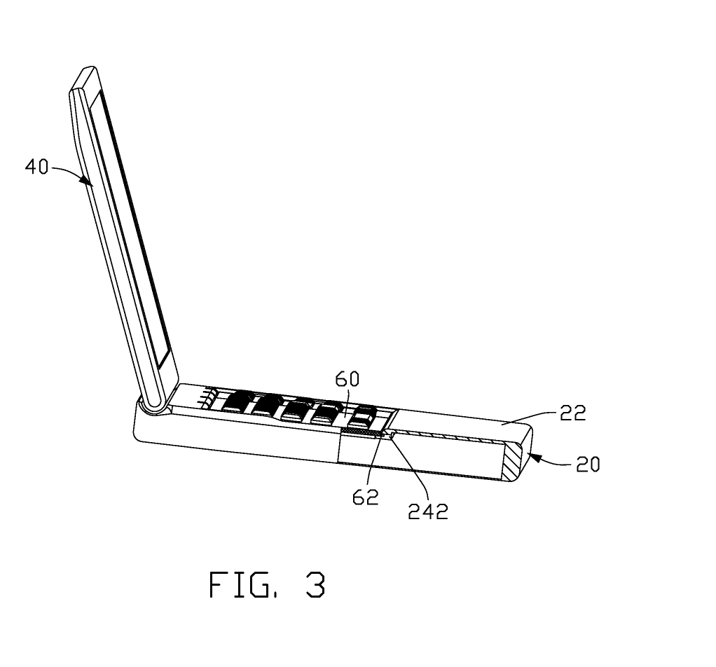

Referring to FIGS. 2 and 3, in assembling the main keyboard 60 and the numeric keypad 80, the main keyboard 60 is for being received in the depressed region 24 of the base unit 20. The projections 62 of the main keyboard 60 are received in the corresponding receiving slots 242 of the base unit 20 to pivot the main keyboard 60 to the base unit 20. The main keyboard 60 is pivoted about the projections 62 until the mounting tabs 64 of the main keyboard 60 are received in the corresponding cutouts 244 of the base unit 20. A plurality of screws 68 are inserted through the through holes 66 of the corresponding mounting tabs 64 of the main keyboard 60, and engage in the corresponding threaded holes 246 of the base unit 20. Thus, the main keyboard 60 is mounted to the base unit 20. The numeric keypad 80 is for being received in the depressed region 24 of the base unit 20 adjacent the main keyboard 60. The protrusions 82 of the numeric keypad 80 are received in the corresponding receiving slots 242 of the base unit 20 to pivot the numeric keypad 80 to the base unit 20. The numeric keypad 80 is pivoted about the protrusions 82 until the fixing tabs 84 of the numeric keypad 80 are received in the corresponding cutouts 244 of the base unit 20. A plurality of screws 88 are inserted through the through-holes 86 of the corresponding fixing tabs 64 of the numeric keypad 80, and engage in the corresponding threaded holes 246 of the base unit 20. Thus, the numeric keypad 80 is mounted to the base unit 20.

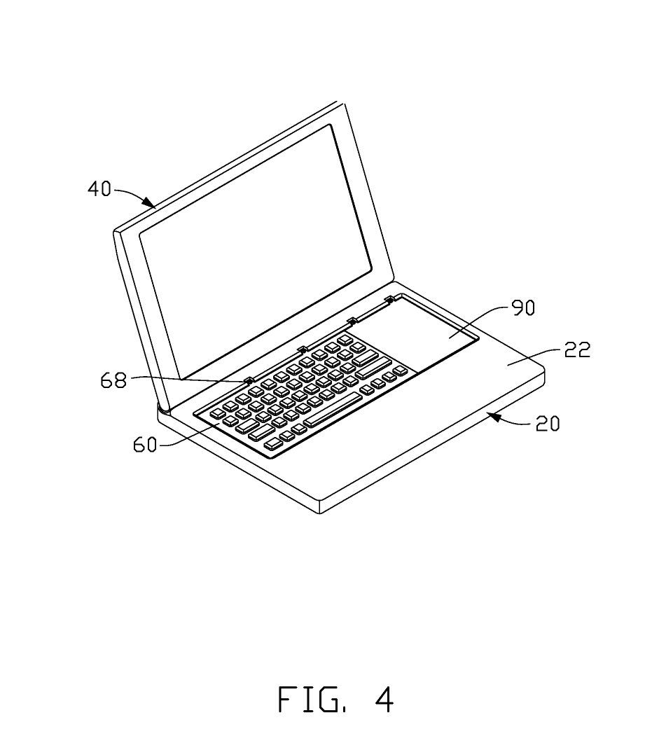

Referring to FIG. 4, in a second preferred embodiment, the input device is a graphics tablet 90.

The keys of the main keyboard 80 includes a plurality of letter keys, a plurality of numeric keys, a plurality of function keys, and so on. Thus, the main keyboard 80 can match demands of common users. According to demands of special users, the input device can be a numeric keypad 80, a graphics tablet 90, or other tablet configured for inputting one type of single special singal.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A portable computer, comprising:
a base unit;
a cover unit pivotably connected to the base unit;
a main keyboard mounted to the base unit, the main keyboard comprising a plurality of keys; and
an input device replaceably mounted to the base unit, for inputting one type of single special singal.

2. The portable computer as claimed in claim 1, wherein the base unit comprises a top plate, the top plate forms a depressed region, the main keyboard and the input device are received in the depressed region of the top plate, the cover unit comprises a screen, the screen is adjacent the top plate of the base unit when the portable computer is closed.

3. The portable computer as claimed in claim 2, wherein the main keyboard defines a plurality of through holes therein, the depressed region of the base unit defines a plurality of threaded holes therein, a plurality of screws are inserted through the corresponding through holes of the main keyboard, and engage in the corresponding threaded holes of the base unit.

4. The portable computer as claimed in claim 3, wherein the main keyboard forms a plurality of mounting tabs on a side thereof, the through holes are defined in the mounting tabs, and the depressed region of the base unit defines a plurality of cutouts in a side thereof, the mounting tabs of the main keyboard are received in the corresponding cutouts of the base unit.

5. The portable computer as claimed in claim 4, wherein the main keyboard further forms a plurality of projections on an opposite side thereof, the depressed region of the base unit further forms a plurality of receiving slots on an opposite side thereof, the projections of the main keyboard are received in the corresponding receiving slots of the base unit.

6. The portable computer as claimed in claim 2, wherein the input device defines a plurality of through-holes therein, the depressed region of the base unit defines a plurality of threaded holes therein, a plurality of screws are inserted through the corresponding through-holes of the input device, and engage in the corresponding threaded holes of the base unit.

7. The portable computer as claimed in claim 6, wherein the input device forms a plurality of fixing tabs on a side thereof, the through-holes are defined in the fixing tabs, and the depressed region of the base unit defines a plurality of cutouts in a side thereof, the mounting tabs of the input device are received in the corresponding cutouts of the base unit.

8. The portable computer as claimed in claim 6, wherein the input device further forms a plurality of protrusions on an opposite side thereof, the depressed region of the base unit further forms a plurality of receiving slots on an opposite side thereof, the protrusions of the input device are received in the corresponding receiving slots of the base unit.

9. The portable computer as claimed in claim 1, wherein the input device is a numeric keypad.

10. The portable computer as claimed in claim 1, wherein the input device is a graphics tablet.

11. A portable computer, comprising:
a base unit, the base unit comprising a top plate, the top plate forms a depressed region;
a main keyboard mounted to the depressed region; and
an input device detachably mounted to the depressed region and lying next to the main keyboard.

12. The portable computer as claimed in claim 11, wherein the main keyboard is mounted to the depressed region by screws.

13. The portable computer as claimed in claim 11, wherein the input device is mounted to the depressed region by screws.

14. The portable computer as claimed in claim 11, wherein the input device is a numeric keypad.

15. The portable computer as claimed in claim 11, wherein the input device is a graphics tablet.

16. A portable computer, comprising:
a base unit comprising a depressed region comprising a first zone and a second zone communicating with the first zone;
a main keyboard detachably mounted to the first zone of the depressed region, the main keyboard having a plurality of letter keys, numeric keys and function keys mounted thereon;
an input device having one type of single special function detachably mounted to the second zone of the depressed region; and
a cover unit pivotably connected to the base unit.

17. The portable computer as claimed in claim 11, wherein the first zone has an area greater than that of the second zone.

18. The portable computer as claimed in claim 16, wherein the input device forms a projection on one side thereof, and the base unit defines a receiving slot communicating with the second zone of the depressed region, the projection being configured to insert into the receiving slot to allow the input device being pivoted to the base unit.

19. The portable computer as claimed in claim 18, wherein the input device further forms a tab extending from an opposite side thereof, and the base unit further defines a cutout communicating with the second zone of the depressed region and receiving the tab therein, a screw extending through the tab to engage with the base unit.

20. The portable computer as claimed in claim 19, wherein the input device is one of numeric keypad and graphics tablet.
